(19) United States
(12) Patent Application Publication
(10) Pub. No.: US 2016/0313599 A1
(43) Pub. Date: Oct. 27, 2016

(54) LIQUID CRYSTAL DISPLAY DEVICE

(71) Applicant: Samsung Display Co., Ltd., Yongin-si (KR)

(72) Inventors: Junghyun KWON, Seoul (KR); Seontae YOON, Seoul (KR); Youngmin KIM, Yongin-si (KR); Haeil PARK, Seoul (KR)

(21) Appl. No.: 15/043,896

(22) Filed: Feb. 15, 2016

(30) Foreign Application Priority Data
Apr. 24, 2015 (KR) 10-2015-0058172

(51) Int. Cl. G02F 1/1335; G02F 1/1333

(52) U.S. Cl. CPC G02F 1/133514; G02F 1/133528; G02F 1/133377; G02F 1/133512; G02F 1/133621; G02F 2001/133548; G02F 2001/133357; G02F 2001/133614

(57) ABSTRACT

A liquid crystal display (“LCD”) display device including a substrate; a color filter disposed on the substrate; a first polarizing plate disposed on the color filter; a support layer disposed on the first polarizing plate to define a microcavity; and a liquid crystal layer disposed in the microcavity.

### CROSS-REFERENCE TO RELATED APPLICATION

This application claims the priority from and the benefit of Korean Patent Application No. 10-2015-0058172, filed on Apr. 24, 2015, which is hereby incorporated by reference for all purposes as if fully set forth herein.

### BACKGROUND

1. FIELD

Exemplary embodiments relate to a liquid crystal display (“LCD”) device capable of reducing substrate manufacturing costs and achieving high-definition color reproduction.

2. Discussion of the Background

An LCD device is a type of flat panel display (“FPD”) which has recently found use in a wide range of applications. An LCD device includes two substrates having electrodes formed thereon, and a liquid crystal layer interposed therebetween. Application of a voltage to the two electrodes causes rearrangement of the liquid crystal molecules of the liquid crystal layer such that an amount of transmitted light is controlled.

As a type of the LCD device, a technique of forming a cavity in each pixel and filling the cavity with liquid crystals is being developed to realize a display. The technique includes: forming a sacrificial layer using an organic material or the like, rather than forming an upper panel on a lower panel, removing the sacrificial layer after forming a support member thereon, and filling the empty space formed by the removal of the sacrificial layer with liquid crystals through a liquid crystal inlet. Accordingly, a display device is manufactured.

The LCD device may display colors through the use of a color filter including a fluorescent substance, such as quantum dots. When the color filter, including the fluorescent substance, is utilized, despite the advantages of an enhanced viewing angle and high-definition color reproduction, color crosstalk may occur between adjacent pixels and, thus, display properties may be degraded.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid crystal display (“LCD”) device including an LCD panel using a single substrate.

Additional aspects will be set forth in the detailed description which follows, and, in part, will be apparent from the disclosure, or may be learned by practice of the inventive concept.

An exemplary embodiment of the present invention discloses an LCD display device including: a color filter disposed on a substrate; a first polarizing plate disposed on the color filter; a support layer disposed on the first polarizing plate so as to define a microcavity; and a liquid crystal layer disposed in the microcavity.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is an exploded perspective view illustrating a liquid crystal display (“LCD”) device according to an exemplary embodiment.

FIG. 2 is a cross-sectional view illustrating the LCD device of FIG. 1.

FIG. 3 is an exploded perspective view illustrating an LCD device according to a second exemplary embodiment.

FIG. 4 is a cross-sectional view illustrating the LCD device of FIG. 3.

FIG. 5 is an exploded perspective view illustrating an LCD device according to a third exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

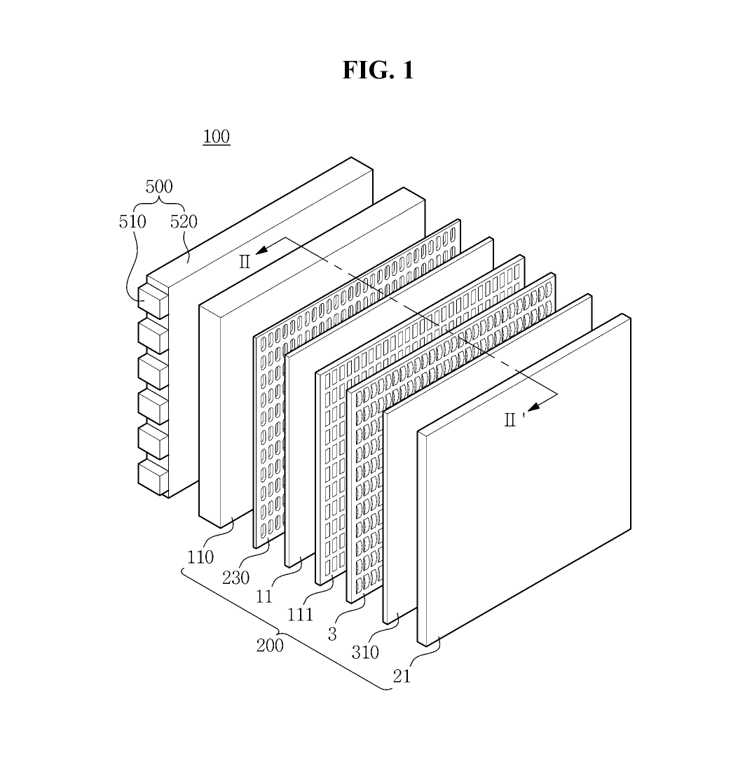

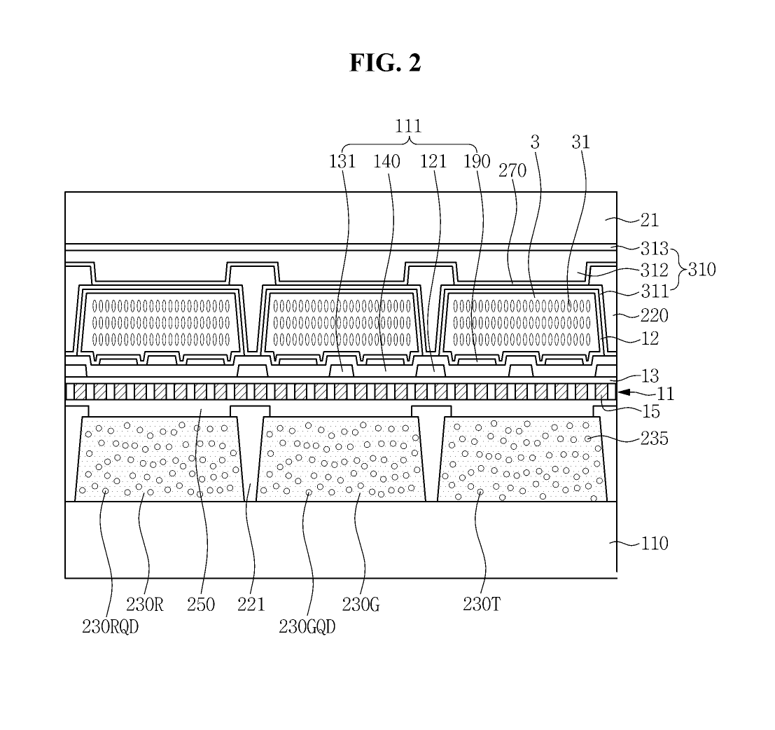

FIG. 1 is an exploded perspective view illustrating the LCD device 100 according to the first exemplary embodiment. FIG. 2 is a cross-sectional view illustrating the LCD device 100 of FIG. 1.

As illustrated in FIG. 1, the LCD device 100 according to the first exemplary embodiment may include an LCD panel 200 and a backlight unit 500.

The backlight unit 500 may include a blue light source 510 and a light guide plate 520. The LCD panel 200 disposed thereabove may include a substrate 110, a color filter 230, a first polarizing plate 11, a wiring layer 111, a liquid crystal layer 3 formed in a microcavity, an insulating layer 310, and a second polarizing plate 21.

In reference to FIGS. 1, 2, and 3, a first light shielding member 221 may be formed on the substrate 110, which may be formed of a transparent material, such as glass or plastic. The first light shielding member 221 may have an aperture, and within each aperture, the color filter 230 corresponding to a color displayed by the corresponding pixel may be formed. The first light shielding member 221 may include a material that does not transmit light, and the material that does not transmit light may include, for example, a black printing material and may further include a light absorbing material, such as chromium (Cr).

A red color filter 230R may be formed in a red pixel, a green color filter 230G may be formed in a green pixel, and a transparent color filter 230T may be formed in a blue pixel. The reason why the transparent color filter 230T is used in the blue pixel is because a blue light source is used as the light source 510 of the backlight unit 500 illustrated in the first exemplary embodiment of FIGS. 1 and 2.

The red color filter 230R may include red quantum dot particles 230RQD, and may convert the color of light supplied from the blue light source 510 into a red color.

The green color filter 230G may include green quantum dot particles 230GQD, and may convert the color of light supplied from the blue light source 510 into a green color.

In addition, the transparent color filter 230T may include scattering particles 235, which may not convert a wavelength of light supplied from the blue light source 510 but may vary a propagation direction of the light. The scattering particle 235 may be, for example, a TiO₂ particle and the like, and may have a size corresponding to a size of the red quantum dot particle 230RQD or the green quantum dot particle 230GQD.

According to the first exemplary embodiment, light supplied from the light source 510 of the backlight unit 500 may be scattered by the red quantum dot particles 230RQD, the green quantum dot particles 230GQD, and the scattering particles 235, and then emitted outwards to display an image. Thus, the light emitted outwards may propagate over a relatively large area, and a gray scale of the light does not vary based on position. Thus, a wide viewing angle may be realized.

The color filter 230 may be elongated along a column of the pixel electrode 190, and pixels of the same color may be arranged along its column direction. The color filter 230 may not be limited to displaying three primary colors of red, green, and blue, and in some exemplary embodiments, may represent one of cyan, magenta, yellow, and white.

An overcoat layer 250 may be formed on the first light shielding member 221, the red color filter 230R, the green color filter 230G, and the transparent color filter 230T. The overcoat layer 250 may be formed of an organic material, and may be omitted in some exemplary embodiments.

The first polarizing plate 11 may be formed on the overcoat layer 250. The first polarizing plate 11 may oppose the wiring layer 111 with an interlayer insulating layer 13 interposed therebetween. The first polarizing plate 11 may be disposed between the color filter 230 and the liquid crystal layer 3, so as to polarize light output from the backlight unit 500 to propagate toward the liquid crystal layer 3.

The first polarizing plate 11 may include a plurality of grid polarizing layers 15 including a material that may reflect light, such as metal, and in this case, the first polarizing plate 11 may transmit or reflect a component of light based on an oscillating direction of the light component incident onto the first polarizing plate 11. The plurality of grid polarizing plates 15 may each extend in a transverse direction, and the plurality of grid polarizing plates 15 may be spaced apart from each other at a pitch to be arranged in a longitudinal direction. In this regard, in a case where the pitch is less than a wavelength of the light component, the plurality of grid polarizing plates 15 may serve as a wire grid polarizer, which may polarize or reflect a light component, based on an oscillating direction of the light component.

The interlayer insulating layer 13 may be formed on the first polarizing plate 11. The interlayer insulating layer 13 may insulate the first polarizing plate 11 and the wiring layer 111 from each other, and may be formed of an organic material.

The wiring layer 111 including a thin film transistor (not illustrated) or the like may be formed on the interlayer insulating layer 13. The wiring layer 111 may include a gate line 121, a storage voltage line 131, a gate insulating layer 140, a data line (not illustrated), a passivation layer (not illustrated), and a pixel electrode 190, and the thin film transistor may be connected to the gate line 121 and the data line. Configurations of the pixel electrode 190, the gate line 121, and the data line formed on the wiring layer 111 may vary in accordance with different exemplary embodiments.

The gate line 121 and the storage voltage line 131 may be disposed below the gate insulating layer 140, and may be electrically separated from each other. The data line may be insulated from and intersect the gate line 121 and the storage voltage line 131. A gate electrode on the gate line 121 and a source electrode on the data line may constitute a control terminal and an input terminal of the thin film transistor, respectively. Further, an output terminal (drain electrode) of the thin film transistor may be connected to the pixel electrode 190, and the pixel electrode 190 may be insulated from the gate line 121, the storage voltage line 131, and the data line.

A support layer 311 may be disposed above the pixel electrode 190 and the passivation layer. The support layer 311 may support various elements, such as a common electrode 270, to be described further below, so as to secure a space (hereinafter referred to as “microcavity” (not illustrated)), which is an inner space of the support layer 311 and space above the pixel electrode 190 and the passivation layer. The support layer 311 according to the first exemplary embodiment may have a trapezoidal cross-section and may have a liquid crystal inlet (not illustrated) on a side surface thereof so as to inject liquid crystals into the microcavity. The support layer 311 may include an inorganic insulating material, such as silicon nitride (SiNₓ).

An alignment layer 12 may be formed inside the support layer 311, and above the pixel electrode 190 and the passivation layer so as to align liquid crystal molecules injected into the microcavity. The alignment layer 12 may include at least one of substances commonly used to form a liquid crystal alignment layer, for example, polyamic acid, polysiloxane, polyimide, or the like.

The liquid crystal layer 3 may be formed inside the alignment layer 12 of the microcavity, and by the alignment layer 12, liquid crystal molecules 31 may be aligned into an initial alignment. The thickness of the liquid crystal layer 3 may be in a range of about 5 μm to about 6 μm.

A second light shielding member 220 may be formed between the support layers 311 adjacent to each other. The second light shielding member 220 may include a material that prevents light transmission and may have an aperture, which may correspond to the microcavity.

The common electrode 270 may be formed above the support layer 311 and the second light shielding member 220. The common electrode 270 and the pixel electrode 190 may be formed of a transparent conductive material, such as indium tin oxide (ITO) or indium zinc oxide (IZO), and may generate an electric field to control alignment direction of the liquid crystal molecules 31.

A planarization layer 312 may be formed on the common electrode 270. The planarization layer 312 may serve to eliminate a step difference formed on the common electrode 270 due to the second light shielding member 220 and may include an organic material. The position of the planarization layer 312 may differ from the disposition thereof illustrated in FIG. 2, and the planarization layer 312 may be disposed below the common electrode 270, or may be omitted.

A patterned insulating layer 313 may be formed above the planarization layer 312. The patterned insulating layer 313 may include an inorganic insulating material, such as silicon nitride (SiNₓ). The planarization layer 312 and the patterned insulating layer 313, along with the support layer 311, may be patterned together to form the liquid crystal inlet (not illustrated). In some exemplary embodiments, the patterned insulating layer 313 may be omitted.

In FIG. 2, the support layer 311, the planarization layer 312, and the patterned insulating layer 313 may be collectively illustrated as a single insulating layer 310. As illustrated in FIG. 2, the common electrode 270 may be disposed between the support layer 311 and the planarization layer 312. However, in some exemplary embodiments, the common electrode 270 may be disposed above the planarization layer 312 or the patterned insulating layer 313, as long as it is disposed above the support layer 311.

The second polarizing plate 21 may be disposed above the patterned insulating layer 313. The second polarizing plate 21 may be formed to have a relatively small thickness, for example, a thickness in a range of about 150 μm to about 200 μm. The second polarizing plate 21 may include a polarizing element, which generates a polarized light, and a tri-acetyl-cellulose (TAC) layer, which may secure device durability.

The liquid crystal display panel 200 may be manufactured using the single substrate 110, such that substrate manufacturing costs may be reduced. Further, because the color filter 230 is disposed directly below the liquid crystal layer 3, rather than being formed on a separate display panel, the distance between the color filter 230 and the liquid crystal layer 3 may be reduced. Because of the reduced distance between the color filter 230 and the liquid crystal layer 3, color crosstalk may be prevented and high-definition color may be reproduced. Further, because external light incident onto the color filter 230 is reduced compared to a conventional LCD device, visibility of the LCD device 100 may be improved.

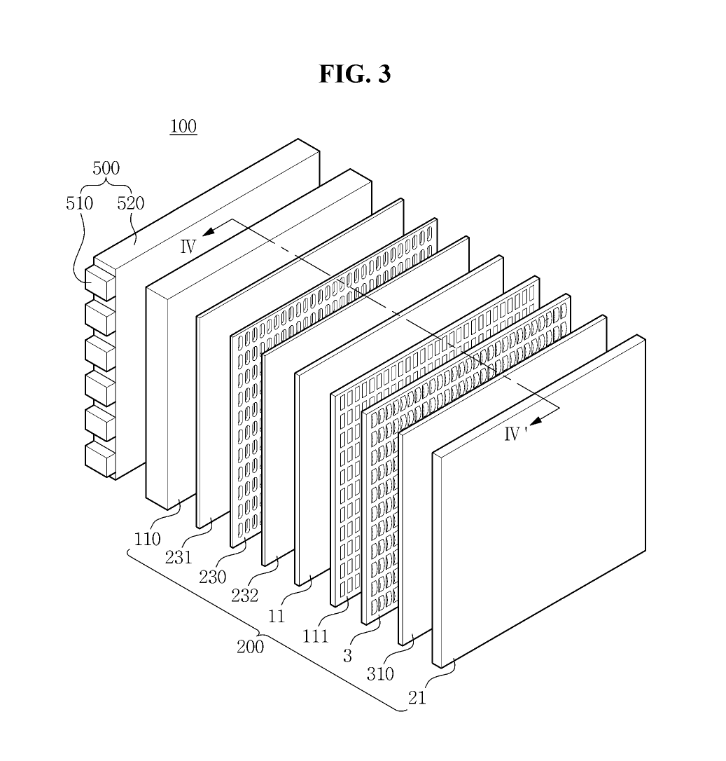

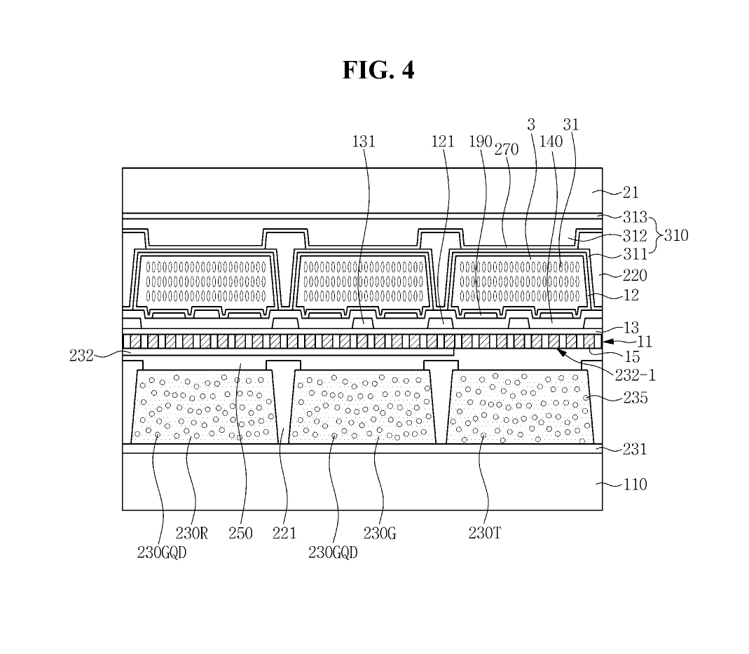

Hereinafter, an LCD device 100 according to a second exemplary embodiment of the present invention will be described in detail with reference to FIGS. 3 and 4.

FIG. 3 is an exploded perspective view illustrating the LCD device 100 according to the second exemplary embodiment. FIG. 4 is a cross-sectional view illustrating the LCD device 100 of FIG. 3.

In reference to FIGS. 3 and 4, the LCD device 100 according to the second exemplary embodiment may further include a blue-light transmission layer 231 between a color filter 230 and a substrate 110 and a blue-light shielding layer 232 between a red color filter 230R and a green color filter 230G.

The blue-light transmission layer 231 may be formed over an entire area of the substrate 110. The blue-light transmission layer 231 may have a structure in which at least two layers having different refractive indices are alternately stacked, and may serve to transmit a component of light in a blue wavelength range and block wavelength ranges other than the blue wavelength range. The light in the blocked wavelength ranges may be reflected off, and thereby light may be recycled. The blue-light transmission layer 231 is configured to transmit blue light incident from a blue light source 510 and to block light in unnecessary wavelength ranges other than the blue wavelength range.

In detail, the blue-light transmission layer 231 may be composed of a dichroic filter. The dichroic filter may reflect a secondary light having a wavelength different from that of a primary light which is incident thereonto, and may selectively transmit a component of light having a wavelength the same as that of the primary light. The primary light corresponds to blue light emitted from the blue light source 510, and the secondary light having a wavelength different from that of the primary light corresponds to red or green light of which the wavelength is converted by the color filter 230.

Accordingly, among the secondary light emitted from the color filter 230, light propagating rearwardly of the LCD panel 200 may be reflected off the blue-light transmission layer 231 to be directed forwardly of the LCD panel 200.

The blue-light transmission layer 231 may have a multi-layer structure in which a thin film formed of a high refractive-index substance and a thin film formed of a low refractive-index substance are alternately stacked. A selective light transmission property of the blue-light transmission layer 231 may be achieved by virtue of high reflectivity attributed to thin film interference over the multi-layer. The substance having a low refractive index may include metal or metal oxide, such as magnesium fluoride (MgF₂) or silicon dioxide (SiO₂), and the substance having a high refractive index may include metal or metal oxide, such as silver (Ag), TiO₂, Ti₂O₃, Ta₂O₃, and the like, but the present invention is not limited thereto. A thickness of each thin film may be determined based on the design thereof, in a range of about an eighth to about half of a wavelength of transmitted light.

When the blue-light transmission layer 231 has a structure in which a plurality of dielectric thin films, each having different refractive indices, are stacked, the thin film interference over the multi-layer may be caused as a result of a mirror surface having a reflectivity much greater than that of metal. Such a blue-light transmission layer 231 may be also referred to as an “edge filter” in the field of optics, and may be designed to have an abrupt transition in reflectivity with respect to a predetermined wavelength.

The blue-light transmission layer 231 may selectively transmit and/or reflect light in a predetermined wavelength range based on a configuration of the dielectric thin film, such that light utilization efficiency may be improved. For example, in a case where the primary light incident onto the color filter 230 is blue light, the blue-light transmission layer 231 may be designed to transmit the blue light and reflect green light and red light. Accordingly, among the green light and red light emitted from the color filter 230, the secondary light that is emitted rearwardly of the LCD panel 200 may be reflected off the blue-light transmission layer 231 to be directed forwardly of the LCD panel 200. In such a manner, the blue-light transmission layer 231 may enhance light efficiency of the LCD device 100.

The blue-light shielding layer 232 may have an aperture 232-1 only in a pixel region for displaying a blue color, and may be formed only in pixel regions for displaying red and green colors. The blue-light shielding layer 232 may have a structure in which at least two layers having different refractive indices are alternately stacked, and may serve to transmit a component of light having a wavelength aside from a blue wavelength range and to block another component of light in the blue wavelength range. The blocked light in the blue wavelength range may be reflected off, and thereby light may be recycled. Because the blue-light shielding layer 232 is configured to prevent light emitted from the blue light source 510 from being directly dissipated outwards, the blue-light shielding layer 232 is absent only in the pixel region for displaying a blue color, but is formed in the pixel regions for displaying red and green colors.

According to the second exemplary embodiment, blue light is utilized as a light source, and thus, the aperture 232-1 is formed in the pixel region for displaying a blue color. However, in some exemplary embodiments, a red light source or a green light source may be utilized, and in this case, an aperture 232-1 may be formed in a pixel region that displays the corresponding color.

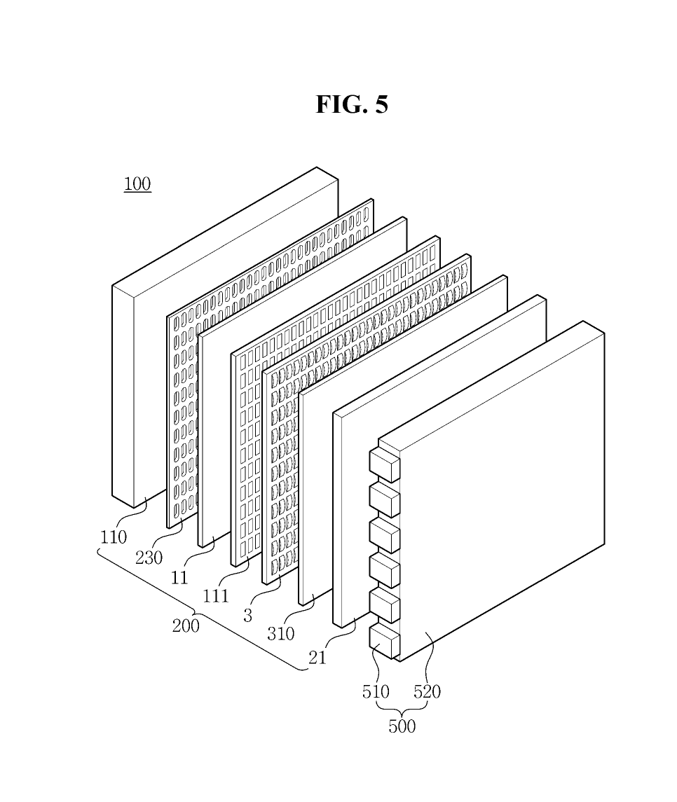

Hereinafter, an LCD device according to a third exemplary embodiment of the present invention will be described in detail with reference to FIG. 5.

FIG. 5 is an exploded perspective view illustrating the LCD device 100 according to the third exemplary embodiment.

In reference to FIG. 5, a backlight unit 500 according to the third exemplary embodiment may be disposed below a second polarizing plate 21, and may include a light source 510 and a light guide plate 520. The visibility of an LCD panel 200 may be degraded as light passes through a liquid crystal layer 3. However, in the third exemplary embodiment, the color filter 230 is disposed upwardly, compared to the liquid crystal layer 3, with respect to the backlight unit 500. Accordingly, light converted in the color filter 230 may not pass through the liquid crystal layer 3, such that the LCD device 100 according to the present exemplary embodiment may have an improved visibility compared to the LCD device 100 according to the first exemplary embodiment.

Meanwhile, although a blue-light transmission layer 231 and a blue-light shielding layer 232 are not disclosed in FIG. 5, the blue-light transmission layer 231 and the blue-light shielding layer 232 may be provided in the present exemplary embodiment as in the second exemplary embodiment.

As set forth above, according to one or more exemplary embodiments, a display device may reduce substrate manufacturing costs, may reproduce a high-definition color by preventing crosstalk, and may be improved in visibility since external light is not incident onto a color filter.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A liquid crystal display device comprising:
a color filter disposed on a substrate;
a first polarizing plate disposed on the color filter;
a support layer disposed on the first polarizing plate to define a microcavity; and
a liquid crystal layer disposed in the microcavity.

2. The liquid crystal display device of claim 1, wherein the first polarizing plate comprises a wire grid polarizer.

3. The liquid crystal display device of claim 2, wherein:
the color filter comprises a red color filter, a green color filter, and a transparent color filter; and
the transparent color filter comprises scattering particles.

4. The liquid crystal display device of claim 3, wherein:
the red color filter comprises red quantum dots; and
the green color filter comprises green quantum dots.

5. The liquid crystal display device of claim 3, further comprising a blue-light transmission layer disposed between the color filter and the substrate.

6. The liquid crystal display device of claim 5, further comprising a blue-light shielding layer disposed between the red color filter and the green color filter.

7. The liquid crystal display device of claim 3, further comprising a backlight unit disposed below the substrate, the backlight unit comprising a light source.

8. The liquid crystal display device of claim 7, wherein the light source comprises a blue light source.

9. The liquid crystal display device of claim 3, further comprising:
a planarization layer disposed on the support layer; and
a second polarizing plate disposed on the planarization layer.

10. The liquid crystal display device of claim 9, further comprising a backlight unit disposed below the second polarizing plate, the backlight unit comprising a light source.

11. The liquid crystal display device of claim 10, wherein the light source comprises a blue light source.

12. The liquid crystal display device of claim 1, further comprising:
a first light shielding member disposed between the color filters; and
an overcoat layer covering the color filter and the first light shielding member.

13. The liquid crystal display device of claim 1, further comprising a second light shielding member disposed between the support layers.

14. The liquid crystal display device of claim 1, further comprising:
a pixel electrode disposed below the support layer; and
a common electrode disposed on the support layer.

15. The liquid crystal display device of claim 1, further comprising an alignment layer disposed on an inner surface of the support layer.
